(19) United States
(12) Patent Application Publication
(10) Pub. No.: US 2006/0154781 A1
(43) Pub. Date: Jul. 13, 2006

(54) Process for operating an automatically actuated friction clutch and/or a transmission

(76) Inventors: Rainer Petzold, Friedrichshafen (DE); Werner Wolfgang, Ravensburg (DE); Thomas Jager, Meckenbeuren (DE); Mario Steinborn, Friedrichshafen (DE); Rupert Kramer, Friedrichshafen (DE); Franz Bitzer, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/327,854

(22) Filed: Jan. 9, 2006

(30) Foreign Application Priority Data
Jan. 13, 2005 (DE) 102005001523.9

(51) Int. Cl. B60W 10/02

(52) U.S. Cl. 477/80

(57) ABSTRACT

The invention concerns a process for operating an automatically actuated friction clutch and/or a transmission within the drive train, in which a torque sensor is assigned to the input shaft of the transmission. In order to improve the operation of such a drive train, it is provided according to the invention that the curve of the measured transmission input torque is determined and evaluated in order to determine the load properties of the friction clutch and/or the transmission.

This application claims priority from German Patent Application No. 10 2005 001 523.9 filed Jan. 13, 2005

### FIELD OF THE INVENTION

The invention concerns a process for operating an automatically actuated friction clutch and/or a transmission within the drive train of a motor vehicle, in which a torque sensor is assigned to the input shaft of the transmission.

### BACKGROUND OF THE INVENTION

It is known that the current engine torque is required for many control functions in a motor vehicle. This current engine torque is usually calculated in the engine control device based on values that are specific to the vehicle as well as the driving condition and that are made available, for example, via electronic interfaces (CAN bus) to other control devices of the motor vehicle. To these control devices belongs also a transmission control system, which controls the actuators in an automatic transmission based on the stored control programs, with which the actuation of a release and startup clutch and/or positioning elements in the automatic transmission can be controlled in order to carry out actions that change the transmission ratio.

The engine torque value, which is usually calculated by the engine control device based on the engine speed, the fuel injection quantity, and other parameters, is at least too inaccurate to control an automatic transmission. The calculated engine torque value can thus deviate more or less from the actual engine torque value because of influences, such as, for example, an auxiliary unit drive on the side of the engine, air losses, dynamic effects, different load pressures of the internal combustion engine, and/or different ambient air pressures. To the dynamic effects belong torque increases when, for example, the engine speed decreases because of an increased driving resistance, and all the rotating parts of the drive train exert a torque-increasing influence with their subsequent rotating masses, or torque reductions when the engine speed increases in the sense of a hoisting effect, because the inert rotating masses of the drive are only brought to the speed that the propulsion engine already has.

Reference is made to DE 102 57 139 A1 in connection with the mentioned inaccuracy of the calculated engine torque value. In this publication, it is initially explained that in automatic transmissions in motor vehicles, the value of the throttle flap opening in the internal combustion engine as well as the vehicle speed can be used as input variables in order to exactly shift up or down the transmission input torque. The transmission input torque is estimated based on the engine speed particularly in electronically controlled transmissions. These estimates are inaccurate, so that torque sensors are customarily used in the transmission input shaft in order to accurately measure the transmission input torque.

From DE 44 40 706 C2 are thus known a process and an apparatus for controlling the shift point of an automatic transmission in dependence upon the inclination rate. The calculation of the climbing force that acts on the motor vehicle, which is known to be a component of the overall driving resistance acting on the motor vehicle, occurs based on sensor data, among other things via the vehicle mass, the vehicle speed, and the air pressure. The current engine torque supplied by the vehicle propulsion engine is either read out from the stored characteristic field or measured by means of a special torque sensor.

From DE 195 13 695 is also known a control apparatus for the lockup clutch of the torque converter of an automatic transmission. In order to increase the service life of the lockup clutch and the converter oil as well as in order to decrease the thermal dissipation loss of the lockup clutch, the clutch control apparatus is equipped with means for determining the desired slip values, with which the slip speed can be adjusted in a continuous slip operation of the lockup clutch in dependence upon the speed of the input element of the clutch, the engine speed, and the accelerator pedal activity.

In addition, it is provided in this control apparatus that a torque sensor measures the torque applied on the crankshaft of the motor vehicle propulsion engine or on the pump side of the torque converter, and not possibly on the transmission input shaft, and makes this measurement available to the control apparatus. This publication discloses, in addition, that a type of emergency operation for the converter lockup clutch is possible with the control apparatus. During this emergency operation, the desired slip value is set to a minimum value, if the converter oil temperature has exceeded an inadmissibly high value due to a malfunction of the converter lockup clutch or the torque converter.

In order to optimize the clutch functions in automatically shifting vehicle transmissions, it is also known that it is necessary to have knowledge concerning which clutch travel distance of a clutch actuator can transfer which torque from the input side of the clutch to its output side. This torque transferability of the clutch is a function that is individual to the clutch and is also called clutch characteristic.

This clutch characteristic is usually learned in a self-learning process by a clutch or transmission control device provided for this purpose and stored in a characteristic field, so that a calculated transmission input torque value is assigned to each clutch travel distance. In order to learn the clutch characteristic, an engine torque is adjusted at the propulsion engine and the clutch actuator is then actuated. In dependence upon the actuator travel distance, the clutch is transferred from an open position to a closed position. In this way, no torque is initially transferred; however, torques that become ever greater are transferred via the clutch with an increasing travel distance. The portion of the torque that is guided via the clutch is determined by means of a comparison of the engine speed and the transmission input speed. As soon as the two mentioned speeds are identical with a precalculated torque, it can be assumed that the torque that is applied on the clutch input side (crankshaft) is also transferred without slip to the clutch output side (transmission input shaft).

Since the calculation of the engine torque is fraught with errors, as described above, these errors form also in the determination of the clutch characteristic, so that these errors can be of a different magnitude in dependence upon the situation.

### DETAILED DESCRIPTION OF THE INVENTION

Against this background, it is an object of the invention to present a process for operating an automatically actuated friction clutch and/or a transmission within the drive train of a motor vehicle, with which the clutch characteristic can be learned more accurately than before by a control device provided for this purpose. In addition, the possibility should be provided for the driver to carry out the clutch actuation in a more comfortable manner with a reduced wear. Finally, it should be possible to determine more accurately than until now the mechanical loads that act on the transmission within the drive train and to have these ready for diagnostic purposes.

This object can be attained with the features disclosed in the main claim, while advantageous embodiments and further developments of the invention can be drawn from the dependent claims.

The invention is based on the knowledge that the shifting comfort as well as the service life of the clutch can be considerably improved or extended in a transmission with an automatic clutch, if the calculated engine torque values can no longer be drawn from as before in order to determine the clutch characteristic, but instead the torque measured at the transmission input shaft by means of the torque sensor is utilized.

Accordingly, the invention is based on a process for operating an automatically actuated friction clutch and/or a transmission within the drive train of a motor vehicle, in which a torque sensor is assigned to the input shaft of the transmission. In order to attain the object, it is provided that the curve of the measured transmission input torque is determined and evaluated in order to determine the load properties of the friction clutch and/or the transmission.

According to an advantageous embodiment of the invention, it is provided for this purpose that the clutch transfer torque is determined in dependence upon the pedal travel of the clutch, that is, in dependence upon the clutch characteristic, from the curve of the measured transmission input torque during the actuation process of the clutch. In this way, the clutch travel distance is of course also measured and drawn from to determine the clutch characteristic. This will be explained in more detail further below.

According to a variation of the invention, it can be provided that the clutch characteristic is determined during the actuation of the clutch by means of a comparison of the torque determined at the input side of the clutch and also at the transmission input side. Two torque sensors are then required, however, in order to carry out the process.

In accordance with a second variation, it is proposed that, beside the transmission input torque, also the engine speed and the speed of the transmission input shaft be measured and evaluated in the manner described above in order to determine the clutch characteristic. Accordingly, if the speeds are identical, it is assumed that the clutch is completely closed and transfers the torque made available by the propulsion engine free of slip to the transmission input shaft. In addition, it can be provided that the measured value of the clutch pedal travel is checked for feasibility by means of a comparison of the engine speed and the speed of the transmission input shaft in addition to the above-described mode of operation.

As mentioned, the value of the travel distance of the clutch actuator is required to control the clutch. This travel distance value is made available to the clutch or to the clutch actuator in a known manner by a travel distance sensor. It cannot be excluded now that the travel distance sensor is defective or its sensor line to the transmission or clutch control device is interrupted.

The invention provides that the clutch characteristic that was accurately measured previously with the aid of the torque at the transmission input shaft can also be utilized for a constant plausibility check of the travel distance signal. For this purpose, the clutch travel distance that belongs to the measured transmission input torque value is sought from the characteristic field of the clutch characteristic and compared to the measured clutch travel distance. As long as these two values coincide within the scope of permissible error limits, it is assumed that the travel distance sensor and the sensor line are in order. If, however, an impermissibly high deviation is detected, an error message directed to the driver and/or motor vehicle control devices indicating this can be generated or displayed.

In this way, a travel distance measuring value that indicates, for example, an open clutch, can be evaluated as implausible, even though a torque is measured at the transmission input shaft. In this way, malfunctions of the clutch operating system and assigned sensors can be detected early and the corresponding emergency processes can be utilized.

In another malfunction case, in which, for example, the disk spring of the clutch is partially broken or the friction lining of the clutch is contaminated with oil, this leads likewise to deviations between the latest learned clutch characteristic and the measured values for the clutch travel distance or transmission input torque. Concretely, the clutch can transfer in such situations only a reduced torque. According to a further variation of the invention, it can therefore be provided that the value of the clutch pedal travel is checked for feasibility with the aid of the once accurately determined clutch characteristic by means of a comparison of the torque determined at the input side of the clutch as well as at the transmission input shaft.

It is also considered advantageous if in another embodiment of the invention, the value of the clutch pedal travel as well as the torque at the transmission input shaft is determined, these two measured values are then compared to corresponding values of the learned clutch characteristic and, if a predetermined deviation occurs between the measured transmission input torque and the transmission input torque expected from the clutch characteristic, an acoustic and/or optic signal is generated, which calls the attention of the driver of the vehicle toward a malfunction in the drive train.

According to the invention, if in a measured clutch closing stroke the measured transmission input torque is lower than the torque value of the clutch characteristic corresponding to this clutch closing stroke, it can be assumed that a mechanical damage has occurred in the clutch operating device or that an excessively high thermal strain due to impermissibly high differential speeds has occurred between the input element and the output element of the clutch. In such a case, it is notified to the driver as a malfunction and the measures geared toward maintaining the vehicle safety are initiated.

Clutches are known to have the property that the torque transfer capacity changes over the clutch travel distance as a consequence of its frequent actuation, which is called setting characteristic. In addition, the contact pressure of the disk spring of the clutch also changes with increasing time of operation of the clutch in dependence upon the wear of the clutch lining. Both effects can be monitored over the service life of the clutch by means of reiterative learning operations and can be taken into consideration in the clutch actuating functions. The invention provides accordingly in a further variation that the clutch transfer torque is learned anew periodically or non-periodically in dependence upon the pedal travel of the clutch (clutch characteristic).

The friction energy or the frictional work of the clutch is calculated In order to monitor the application conditions and/or for preventive wear detection of the clutch. The calculation results are used to inform the driver with regard to the exceeding of corresponding limit values, in order to initiate autonomous measures for the protection of the clutch, in order to determine the clutch wear condition, and in order to prognosticate the expected service life of the clutch. According to a further variation of the invention, it is provided that the transmission input torque measured at the transmission input shaft is used in order to calculate the previously mentioned values. The mentioned values can be accurately determined by means of this measure of the process, and this noticeably improves the travel properties with respect to other technical solutions.

It is finally a component part of the invention that the torques transferred by the clutch and/or the transmission are measured by the torque sensor at the transmission input shaft, are classified within a predetermined torque class, and are added up within these classes. These cumulative torque values are evaluated in such a way by means of diagnostic software that corresponding wear and/or damage notifications are transmitted to the driver if predetermined cumulative torque values or maximum clutch and/or transmission loads are exceeded.

1-10. (canceled)

11. A method for operating one or more of an automatically actuated friction clutch and a transmission within a drive train of a motor vehicle, the method comprising the steps of:
assigning a torque sensor to the input shaft of the transmission;
determining a curve of the measured transmission input torque; and
evaluating the curve of the measured transmission input torque to determine load properties of one or more of the friction clutch and the transmission.

12. The method of claim 11, further comprising the step of determining a clutch transfer torque in dependence upon a pedal travel of the clutch (clutch characteristic) from the curve of the measured transmission input torque during an actuation process of the clutch.

13. The method of claim 12, further comprising the step of determining a clutch characteristic during actuation of the clutch by means of a comparison of torque values measured at an input side of the clutch as well as at an output shaft.

14. The method of claim 12, further comprising the step of evaluating an engine speed and a speed of the transmission input shaft in order to determine a clutch characteristic.

15. The method of claim 11, further comprising the step of checking a value of the clutch pedal travel for feasibility by means of a comparison of an engine speed and a transmission input shaft speed.

16. The method of claim 11, further comprising the step of checking a value of the clutch pedal travel for feasibility with aid of a clutch characteristic by means of a comparison of torque determined at an input side of the clutch as well as at the transmission input shaft.

17. The method of claim 11, further comprising the step of determining a value of the clutch pedal travel and a value of the torque at the transmission input shaft, comparing the value of the clutch pedal travel and the value of the torque at the transmission input shaft to corresponding values of a learned clutch characteristic, and if a predetermined deviation occurs between the measured transmission input torque value and the transmission input torque expected from the learned clutch characteristic, one or more of an acoustic and optic signal is generated, which calls attention of a driver of the vehicle toward a malfunction within the drive train.

18. The method of claim 11, further comprising the step of assuming mechanical damage has occurred in a clutch operating device or an excessively high thermal strain due to impermissibly high differential speeds has occurred between an input element and an output element of the clutch if in a measured clutch closing stroke, the measured transmission input torque is lower than a torque value of a clutch characteristic corresponding to the clutch closing stroke, and notifying the driver of a malfunction and initiating measures geared toward maintaining the vehicle safety.

19. The method of claim 11, further comprising the step of learning anew the clutch transfer torque either periodically or non-periodically depending on a pedal travel of the clutch (clutch characteristic).

20. The method of claim 11, further comprising the step of classifying torque values measured at the transmission input shaft within predetermined torque groups and adding up the torque values measured within the groups, evaluating the cumulative torque values, and transmitting corresponding wear and damage notifications to a driver if one or more predetermined cumulative torque values or maximum clutch and transmission loads are exceeded.
